(19) United States
(12) Patent Application Publication
(10) Pub. No.: US 2019/0228580 A1
(43) Pub. Date: Jul. 25, 2019

(54) Dynamic Creation of Augmented Reality Effects

(71) Applicant: Facebook, Inc., Menlo Park, CA (US)

(72) Inventors: Martin Pelant, London (GB); Yiting Li, Milpitas, CA (US); Dominic Akira Burt, London (GB); Hermes Germi Pique Corchs, London (GB); Mircea-Gabriel Suciu, London (GB); Guk Hyeon Chai, Sunnyvale, CA (US); Michael Slater, Nottingham (GB); Dolapo Omobola Falola, London (GB)

(21) Appl. No.: 15/879,285

(22) Filed: Jan. 24, 2018

(51) Int. Cl. G06T 19/00; G06T 17/20; G06T 15/04; G06T 19/20; G06K 9/00

(52) U.S. Cl. CPC G06T 19/006; G06T 17/205; G06T 15/04; G06T 19/20; G06K 9/00228; G06T 2200/24; G06K 9/00362; G06T 2215/16; G06T 2219/2012; G06T 2200/04; G06K 9/00281

(57) ABSTRACT

In one embodiment, a method includes recognizing an object in an image that is captured by a camera and presented in a region of a screen of the computing device, generating a 3-dimensional mesh representation for the object by recognizing visual components of the object, where the 3-dimensional mesh representation comprises a plurality of polygons, receiving one or more inputs from the user, where the inputs cause color information for at least a part of the region of the screen to be updated, identifying one of the plurality of polygons that corresponds to a first region of the screen, identifying an area of the texture layer that corresponds to the identified polygon, recording the updated color information in the identified area of the texture layer, generating an augmented reality effect associated with the object based on the updated color information recorded in the identified area of the texture layer.

### TECHNICAL FIELD

This disclosure generally relates to Augmented Reality (AR) effects.

### BACKGROUND

Augmented reality provides a view of the real or physical world with added computer-generated sensory inputs (e.g., visual, audible). In other words, computer-generated virtual effects augment or supplement the real-world view. For example, a mobile phone with a camera may capture a real-world scene (as an image or video) and display a composite of the captured scene with computer-generated objects. The virtual objects may be, for example, two-dimensional and/or three-dimensional objects, and it may be stationary or animated. The virtual objects may be configured to be conceptually positioned anywhere within the captured scene. For example, from the perspective of a viewer, a virtual object may be positioned behind or in front of an object in the scene (e.g., a tree, a person, etc.). When the virtual object appears in front of the object in the scene, the virtual object in effect covers a portion of that object. Thus, the covered portion may not be visible to the viewer.

### SUMMARY OF PARTICULAR EMBODIMENTS

A user participating a real-time video conferencing may apply some visual effects on her face during the video conferencing. The visual effects may include adding a simple drawing on the face, painting on a part of the face, or even deforming a part of the face (e.g., nose, lips, eyes, etc.). In particular embodiments, a computing device associated with a user may enable the user to doodle in real-time on a live video of herself. The doodle will in-real time become an augmented reality (AR) effect (e.g., a mask that follows the user's facial movements and orientation). When the user draws a doodle on an object of interest (e.g., eyes, lips, nose, etc.) within her selfie image, the doodle may dynamically adapt to the object of interest. As an example and not by way of limitation, if a user draws something around the lips, then the drawing may follow the contour of the lips. The doodle may dynamically adjust if the user opens or closes her mouth or when she speaks. A doodle may be saved for later reuses as a custom mask. In addition to making doodles on the face, doodles on the body of a user (e.g., chest) may also be possible.

In particular embodiments, a computing device may identify an object of interest presented on a particular region of a screen of the computing device. The object of interest may be a human face. In particular embodiments, the object of interest may be a human body. The computing device may generate a 3-dimensional mesh representation of the object of interest by recognizing visual components of the object of interest. The 3-dimensional mesh representation may comprise a plurality of polygons. Each polygon in the 3-dimensional mesh representation may correspond to a 3-dimensional contour of a visual component of the object of interest. A texture layer may be created when the 3-dimensional mesh representation is generated. An area of the texture layer may correspond to a polygon in the 3-dimensional mesh representation and may store color information for the corresponding polygon. In particular embodiments, a plurality of objects may be presented in the screen. One of the plurality of objects may comprise one or more the other objects. In such a scenario, the computing device may generate a 3-dimensional mesh representation for each of the plurality of objects. The computing device may receive one or more inputs from the user that cause color information for at least a part of the particular region of the screen to be updated. In particular embodiments, the updated color information may be caused by one or more drawings. The drawings may be saved for later uses. In particular embodiments, the updated color information may be caused by a deformed object. The computing device may map the updated color information to the object of interest. If a plurality of objects are presented in the screen, and a plurality of 3-dimensional mesh representations corresponding to the plurality of objects are available, the computing device may select an object among the plurality of objects as the object of interest and map the updated color information to the selected object of interest. The computing device may select the object of interest based on a location of the updated color information and a degree of required precision. In particular embodiments, the computing device may select the object of interest based on a user selection. In order to map the updated color information to the object of interest, the computing device may identify a region of the screen corresponding to each polygon in the 3-dimensional mesh representation for the object of interest. The computing device may determine whether or not color information for the corresponding region of the screen was updated. If the color information for the corresponding region of the screen was updated, the computing device may identify an area of the texture layer corresponding to the polygon. The computing device may record the updated color information for the corresponding region of the screen to the corresponding area of the texture layer. Once a video session starts, the computing device may re-render the object of interest in the screen. In order to re-render the object of interest in the screen for each frame of the video session, the computing device may update the 3-dimensional mesh representation as the object of interest moves based on 3-dimensional object tracking algorithms. The computing device may identify polygons in the 3-dimensional mesh representation that are visible in the screen. The computing device may retrieve, for each identified polygon, color information from the corresponding area of the texture layer. The computing device may apply the retrieved color information to a region of the screen corresponding to the polygon by performing texture mapping algorithms.

The embodiments disclosed herein are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIGS. 1A-1C illustrate an example of AR doodling.

FIG. 2 illustrates an example of generating a 3-dimensional mesh representation of an object.

FIG. 3 illustrates an example mapping between a 3-dimensional mesh representation and a texture layer.

FIGS. 4A-4B illustrate an example background doodle.

FIGS. 5A-5B illustrate an example of a facial part deformation.

FIG. 6 illustrates an example method for creating augmented reality effects in real-time.

FIG. 7 illustrates an example network environment associated with a social-networking system.

FIG. 8 illustrates an example computer system.

### DESCRIPTION OF EXAMPLE EMBODIMENTS

A user participating a real-time video conferencing may apply some visual effects, called doodles, on her face during the video conferencing. The visual effects may include adding a simple drawing on the face, painting on a part of the face, or even deforming a part of the face (e.g., nose, lips, eyes, etc.). In particular embodiments, a computing device associated with a user may enable the user to doodle in real-time on a live video of herself. The doodle will in-real time become an augmented reality (AR) effect (e.g., a mask that follows the user's facial movements and orientation). When the user draws a doodle on an object of interest (e.g., eyes, lips, nose, etc.) within her selfie image, the doodle may dynamically adapt to the object of interest. As an example and not by way of limitation, if a user draws something around the lips, then the drawing may follow the contour of the lips. The doodle may dynamically adjust if the user opens or closes her mouth or when she speaks. A doodle may be saved for later reuses as a custom mask or as a custom doodle. In addition to making doodles on the face, doodles on the body of the user (e.g., chest) may also be possible.

In particular embodiments, a computing device may identify an object of interest presented on a particular region of a screen of the computing device. The object of interest may be a human face. In particular embodiments, the object of interest may be a human body. The computing device may generate a 3-dimensional mesh representation of the object of interest by recognizing visual components of the object of interest. The 3-dimensional mesh representation may comprise a plurality of polygons. Each polygon in the 3-dimensional mesh representation may correspond to a 3-dimensional contour of a visual component of the object of interest. A texture layer may be created when the 3-dimensional mesh representation is generated. An area of the texture layer may correspond to a polygon in the 3-dimensional mesh representation and may store color information for the corresponding polygon. In particular embodiments, a plurality of objects may be presented in the screen. One of the plurality of objects may comprise one or more the other objects. In such a scenario, the computing device may generate a 3-dimensional mesh representation for each of the plurality of objects. The computing device may receive one or more inputs from the user that cause color information for at least a part of the particular region of the screen to be updated. In particular embodiments, the updated color information may be caused by one or more drawings. The drawings may be saved for later uses. In particular embodiments, the updated color information may be caused by a deformed object. The computing device may map the updated color information to the object of interest. If a plurality of objects are presented in the screen, and a plurality of 3-dimensional mesh representations corresponding to the plurality of objects are available, the computing device may select an object among the plurality of objects as the object of interest and map the updated color information to the selected object of interest. The computing device may select the object of interest based on a location of the updated color information and a degree of required precision. In particular embodiments, the computing device may select the object of interest based on a user selection. In order to map the updated color information to the object of interest, the computing device may identify a region of the screen corresponding to each polygon in the 3-dimensional mesh representation for the object of interest. The computing device may determine whether or not color information for the corresponding region of the screen was updated. If the color information for the corresponding region of the screen was updated, the computing device may identify an area of the texture layer corresponding to the polygon. The computing device may record the updated color information for the corresponding region of the screen to the corresponding area of the texture layer. Once a video session starts, the computing device may re-render the object of interest in the screen. In order to re-render the object of interest in the screen for each frame of the video session, the computing device may update the 3-dimensional mesh representation as the object of interest moves based on 3-dimensional object tracking algorithms. The computing device may identify polygons in the 3-dimensional mesh representation that are visible in the screen. The computing device may retrieve, for each identified polygon, color information from the corresponding area of the texture layer. The computing device may apply the retrieved color information to a region of the screen corresponding to the polygon by performing texture mapping algorithms. Although this disclosure describes implementing AR doodling in a particular manner, this disclosure contemplates implementing AR doodling in any suitable manner.

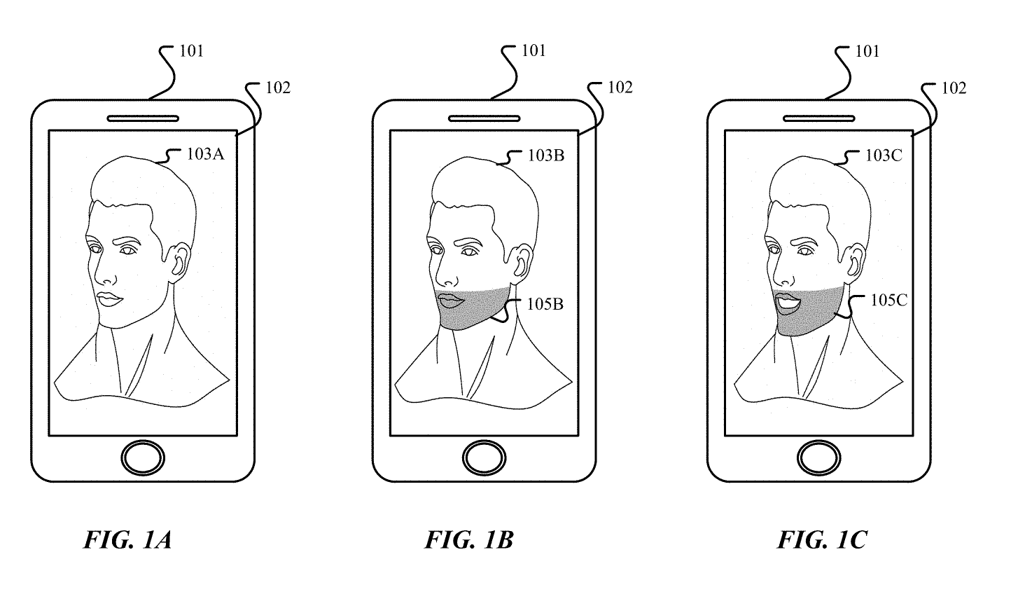

FIGS. 1A-1C illustrate an example of AR doodling. In FIG. 1A, a user takes a selfie of himself using his computing device 101. After the user takes the selfie, the computing device 101 may present the image 103A on a screen 102 of the computing device 101. The user is about to have a video chat session with a group of friends about an upcoming World Cup game. The user may paint his face with the uniform theme color of his national team to express his support for his national team. The painted face is illustrated in FIG. 1B. The user may choose a painting brush and a color using a user interface provided by the application on the computing device 101 and paint lower part of his face 103B with the chosen color by using finger gestures on the touch sensitive screen 102 of the computing device 101. At the end of the painting, a single color painting 105B is placed on the lower part of his face 103B. After painting his face, the user may start the video chat session by choosing a join menu from the user interface of the application. FIG. 1C illustrates an example moment in the middle of the video chat. The user may move his lips while he is talking. The paint 105C may adjust to fit his lower face while the lower part of the face 103C is moving as if the lower part of the face is painted in real world. The friends in the video chat session may also see the AR doodle on the face.

In particular embodiments, the computing device 101 may recognize an object presented on a particular region of a screen 102 of the computing device 101. The computing device 101 may utilize object recognition algorithms to recognize the object in the screen 102. The object may be a human face. The object may be a part of the face (e.g., eyes, lips, nose, etc.). In particular embodiments, the object may be a human body. As an example and not by way of limitation, the computing device 101 may enter into an AR doodling mode based on a user command to enter into the AR doodling mode. In particular embodiments, the computing device 101 may automatically enter into the AR doodling mode without receiving an input from the user. The computing device 101 may recognize a face of the user in the screen 102. The computing device 101 may recognize additional objects within the recognized face including eyes, lips, nose, and other features of the face. Although this disclosure describes recognizing an object in the screen in a particular manner, this disclosure contemplates recognizing an object in the screen in any suitable manner.

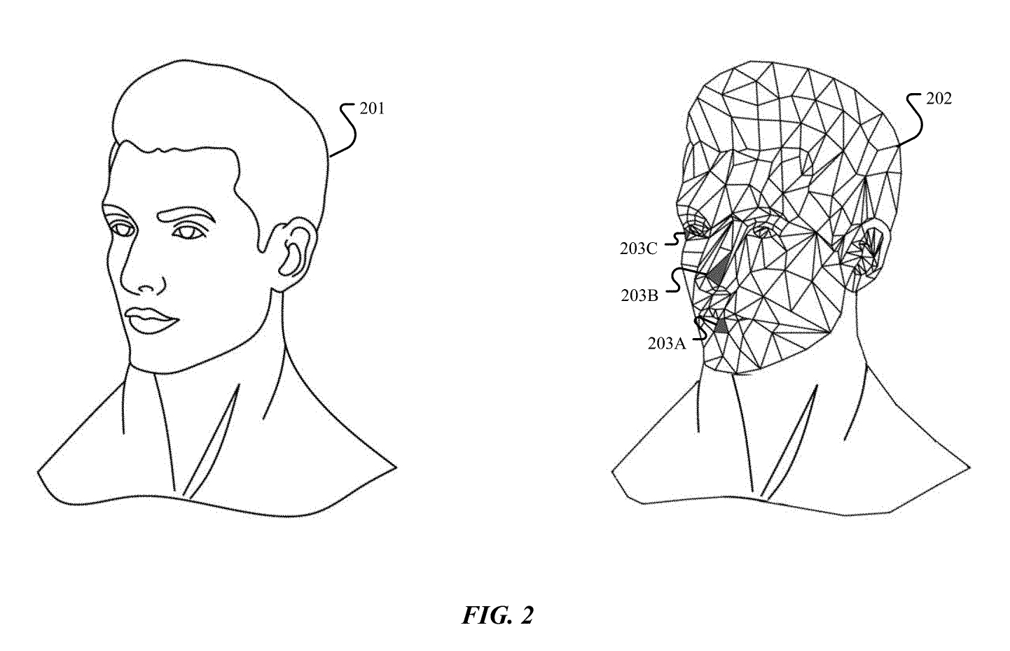

In particular embodiments, the computing device 101 may identify visual components of the recognized object and generate a 3-dimensional mesh representation for the recognized object. The 3-dimensional mesh representation may be a collection of faces, defined by vertices and edges, that define the shape of the object in 3-dimensional computer graphics modeling. The faces may usually be simple convex polygons. Thus, the 3-dimensional mesh representation may comprise a plurality of polygons. Each polygon in the 3-dimensional mesh representation may correspond to a 3-dimensional contour of a visual component of the object. FIG. 2 illustrates an example of generating a 3-dimensional mesh representation of an object. As an example and not by way of limitation, the computing device 101 may recognize a face 201 of a user. The computing device 101 may identify 3-dimensional visual components within the recognized face 201 and generate a 3-dimensional mesh representation 202 of the recognized face 201. Each polygon in the generated 3-dimensional mesh representation may map to a portion of the face 201. For example, A first polygon 203A in the generated 3-dimensional mesh representation may correspond to a portion of the lip. A second polygon 203B may correspond to a portion of the nose, and a third polygon 203C may correspond to a portion of the eyes. Although this disclosure describes generating a 3-dimensional mesh representation for an object in a particular manner, this disclosure contemplates generating a 3-dimensional mesh representation for an object in any suitable manner.

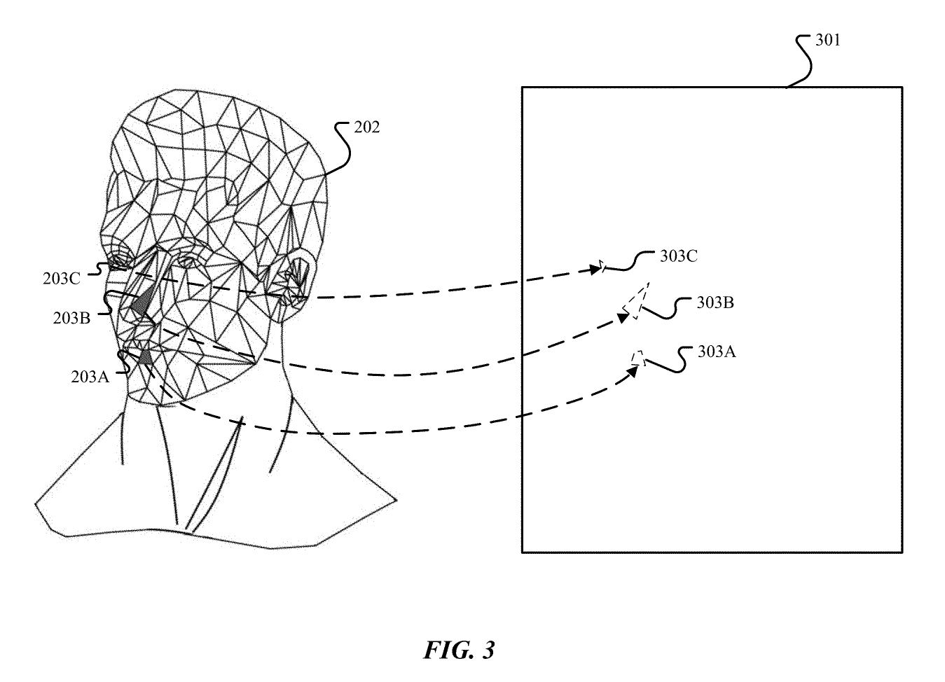

In particular embodiments, a texture layer may be created when the 3-dimensional mesh representation is generated. An area of the texture layer may correspond to a polygon in the 3-dimensional mesh representation and may store color information for the corresponding polygon. When the computing device 101 generates a 3-dimensional mesh representation for an object, the computing device 101 may record, for each polygon of the 3-dimensional mesh representation, corresponding color information collected from the corresponding portion of the object to the corresponding area in the texture layer. The stored color information may be used for texture mapping when the computing device 101 re-renders the object. The texture mapping techniques may be used to construct a realistic and functional 3-dimensional presentation of the object. FIG. 3 illustrates an example mapping between a 3-dimensional mesh representation and a texture layer. As an example and not by way of limitation, the computing device 101 may generate a 3-dimensional mesh representation 202 by using a 3-dimensional object recognition algorithm. The computing device 101 may also create a corresponding texture layer 301, which by default may be transparent. An area 303A of the texture layer 301 corresponds to a polygon 203A of the 3-dimensional mesh representation. The computing device 101 may store color information collected from a corresponding portion of the object to the area 303A of the texture layer 301. An area 303B corresponds to a polygon 203B of the 3-dimensional mesh representation, and an area 303C corresponds to a polygon 203C of the 3-dimensional mesh representation. Although this disclosure describes creating a texture layer in a particular manner, this disclosure contemplates creating a texture layer in any suitable manner.

In particular embodiments, a plurality of objects may be presented in the screen 102. One of the plurality of objects may comprise one or more the other objects. As an example and not by way of limitation, the computing device 101 may recognize a face in the screen 102. The computing device 101 may also recognize a plurality of features in the face, including, but not limited to, nose, lips, eyes, etc. In such a scenario, the computing device 101 may generate a 3-dimensional mesh representation for each of the plurality of objects. The computing device 101 may also create a corresponding texture layer for each of the generated 3-dimensional mesh representation. As an example and not by way of limitation, when the computing device 101 recognizes a face of the user, the computing device 101 may generate a separate 3-dimensional mesh representation for each of the facial features apart from the main facial 3-dimensional mesh representation that corresponds to the user's face. For example, the computing device 101 may generate an eye mesh representation, a nose mesh representation, and a lip mesh representation, etc. Although this disclosure describes generating a plurality of 3-dimensional mesh representations in a particular manner, this disclosure contemplates generating a plurality of 3-dimensional mesh representations in any suitable manner.

In particular embodiments, the computing device 101 may receive one or more inputs from the user that cause color information for at least a part of the particular region of the screen 102 to be updated. In particular embodiments, the updated color information may be caused by one or more drawings. The computing device 101 may allow a user to doodle on the object presented in the screen 102 while the computing device 101 is in an AR doodling mode. While in the AR doodling mode, the user may doodle to the face, body, or a part of the face. The user may select a pen or a paint brush from the user interface of an AR application that enables the user to doodle. The AR application may include video recording application, video conferencing or chatting application, or any suitable application that captures motions of one or more objects. The user may also select a color to draw or paint from a list of available colors from the user interface of the application. The user may draw one or more drawings or paint one or more colors in a portion of an object. When the user finishes the drawing or painting, the user may indicate the end of the AR doodling mode. The computing device 101 may detect the end of the AR doodling mode based on the other facts other than an explicit indication from the user. The computing device 101 may determine that color information for at least a part of the particular region of the screen 102 has been updated as a result of doodling. The drawings may be saved for later uses as a custom AR mask or a personalized doodle. As an example and not by way of limitation, as illustrated in FIG. 1B, the user may paint the lower part of his face with a color. At the end of the painting, the user may click a finish button to indicate that the doodling finishes. The computing device 101 may determine color information for a part of the screen 102 has changed. As another example and not by way of limitation, a user may change the color of her eyes to green. In order to change the color of the eyes, the user may zoom-in the picture in the screen 102 and color the eyes. At the end of coloring, the user may zoom-out the picture and start recording a video of herself. The computing device 101 may detect the end of AR doodling mode based on the fact that the user has started a video recording. The computing device 101 may determine color information for a particular region of the screen 102 has changed. The particular region of the screen 102 may be the region where eyes of the user are presented. Although this disclosure describes determining color information for a region of the screen is updated in a particular manner, this disclosure contemplates determining color information for a region of the screen is updated in any suitable manner.

In particular embodiments, the computing device may map the updated color information to an object appearing in the scene (e.g., the user's face, his eyes, nose, etc.). If a plurality of objects are presented in the screen 102, the computing device may select an object as the object of interest among the plurality of objects and map the updated color information to the object of interest. The computing device may select the object of interest based on a location of the updated color information and a degree of required precision. As an example and not by way of limitation, the user may paint the lower part of his face. Because the painted area covers a significant portion of the face and only low precision mapping is required for the doodle, the computing device 101 may map the updated color information to the face. As another example and not by way of limitation, a user may color her eyes as a doodle. Because the painted area coincides with the eyes in the face and the high precision mapping for the doodle is required, the computing device 101 may map the updated color information to the eyes. In particular embodiments, the user may indicate a request for mapping the updated color information to the eyes. When the user paints her eyes, the user may tap on the region for eyes to zoom-in to the region. The computing device may interpret the tapping as an indication. Although this disclosure describes selecting the object of interest to map the updated color information to in a particular manner, this disclosure contemplates selecting the object of interest to map the updated color information to in any suitable manner.

In particular embodiments, after the computing device has identified the object for which the doodling is intended, the computing device may access the 3-dimensional mesh representation corresponding to that object of interest in order to map the updated color information to particular affected regions on the object of interest. The computing device 101 may also access the texture layer corresponding to the 3-dimensional mesh representation. The computing device 101 may save the updated color information on the texture layer as follows. The computing device 101 may identify a region of the screen 102 that has been doodled on and map the doodle to a 3-dimensional mesh representation. The computing device 101 may further map the doodle to particular polygons of the mesh representation. The identified polygons may then in turn be used to determine an area of the texture layer corresponding to the polygon. For each of the identified polygons, the computing device 101 may record the updated color information for the corresponding region of the screen 102 to the corresponding area of the texture layer. As an example and not by way of limitation, the user may paint her eyes with a color. The computing device 101 may determine to map the doodle (i.e., color in the eyes) to the eyes in the face. The computing device 101 may access the 3-dimensional mesh representation for the eyes, where the computing device 101 generated the 3-dimensional mesh representation for the eyes by performed a 3-dimensional object recognition algorithm. The computing device 101 may also access a texture layer corresponding to the 3-dimensional mesh representation for the eyes. As an example, the user may have painted the iris part of the eyes with a color. The computing device 101 may identify polygons in the 3-dimensional mesh representation corresponding to the iris part of the eyes. For each of the identified polygons, the computing device 101 may collect updated color information from the corresponding region of the screen 102 and store the collected updated color information to the corresponding area of the texture layer. Although this disclosure describes mapping the updated color information to the object of interest in a particular manner, this disclosure contemplates mapping the updated color information to the object of interest in any suitable manner.

In particular embodiments, the computing device 101 may, in real-time, generate the doodled AR effects and present it to the user for each subsequent frame. In order to generate the AR effect, the computing device 101 may update the 3-dimensional mesh representation to track any movements of the object of interest (e.g., by utilizing 3-dimensional object tracking algorithms). The computing device 101 may identify polygons in the 3-dimensional mesh representation that are visible in the screen 102. The computing device 101 may retrieve, for each identified polygon, color information from the corresponding area of the texture layer (which may contain the user's doodles). The computing device 101 may apply the retrieved color information onto the polygons by using a texture mapping algorithm, and then use any suitable rasterizing or similar algorithms to map the color information onto the 2-dimensional screen 102. The updated color information caused by doodling may be stored in the corresponding areas of the texture layer. Because the computing device 101 applies the color information stored in an area of the texture layer to a region of the screen 102 for each identified visible polygon for a given frame, the doodle may adjust to the movements of the object of interest. As an example and not by way of limitation, continuing with the prior example, the user painted iris part of her eyes with a color. The computing device 101 has stored updated color information due to the painting to the texture layer corresponding to the 3-dimensional mesh representation for the eyes. The computing device 101 may then update the 3-dimensional mesh representation following the movements of the eyes. For each frame of a video session, the computing device 101 may identify polygons in the 3-dimensional mesh representation that is visible at the given frame. The computing device 101 may retrieve, for each identified visible polygon, color information from the corresponding area of the texture layer. The computing device 101 may apply, for each identified visible polygon, the retrieved color information, and then map the color information to a region of the screen 102 corresponding to the polygon. As the video session progresses, the user may be seen as if the color of her eyes has changed to the color she painted. Although this disclosure describes generating the doodled AR effects in real-time in a particular manner, this disclosure contemplates generating the doodled AR effects in real-time in any suitable manner.

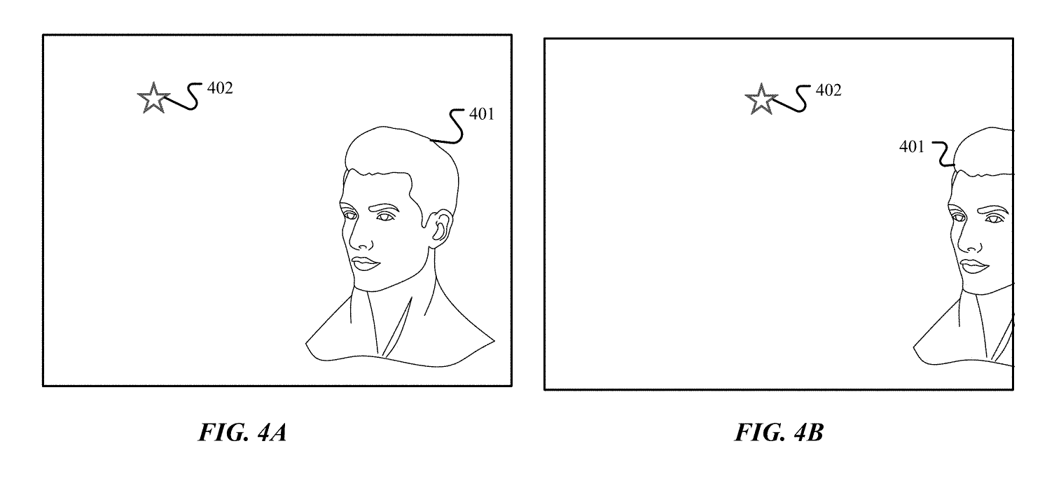

In particular embodiments, a user may create 2D doodles on background outside of any recognizable moving real-world object. At the end of an AR doodling mode, the computing device 101 may determine whether a doodle is intended to be associated with an object (e.g., a face) or the background (e.g., anywhere other than a recognizable moving object) by performing a person segmentation. As an example and not by way of limitation, if the user taps on the eyes, the computing device 101 may determine that the user is likely interested in creating a doodle around the eyes. The computing device 101 may apply doodling to the texture layer corresponding to the 3-dimensional mesh representation for the eyes, as discussed above. In particular embodiments, if the user's doodle extends from an object to an area outside of the object, the doodle may continue to be associated with that object. For example, if the user draws in the video horns that stem from his forehead, the computing device 101 may determine that part of the doodling action has extended outside of the user's facial mesh. As such, instead of storing the doodle in the texture associated with the facial mesh, the computing device 101 may, in particular embodiments, store the doodle in another texture that is associate with another mesh (e.g., a planar mesh) that extends from and tracks the facial mesh. If the user taps on a background space outside of any recognizable moving object, the computing device 101 may determine that the user is interested in creating a background doodle. Background doodles in certain embodiments may not be mapped to any real-world object. Instead, the background doodle may be associated with the background scene, not a person or any moving object. FIGS. 4A-4B illustrate an example background doodle. As an example and not by way of limitation, a user may draw a star 402 outside of the user 401 while the computing device 101 is in an AR doodling mode as illustrated in FIG. 4A. The star 402 may not move while the user is moving, because the star 402 may not being mapped to any mesh that tracks the user. If the user later moves the camera, the star 402 may stick to the point in space where the star 402 was originally drawn as in FIG. 4B. In particular embodiments, the background doodle may be treated as a world AR effect that is fixated at a particular point in the 3D space surrounding and relative to the user. A background doodle may be visible when the user's camera is pointing in the original direction as when the doodle was created, but the drawing may shift out of view as the user rotates the camera. Although this disclosure describes doodling outside of any moving object in a particular manner, this disclosure contemplates doodling outside of any moving object in any suitable manner.

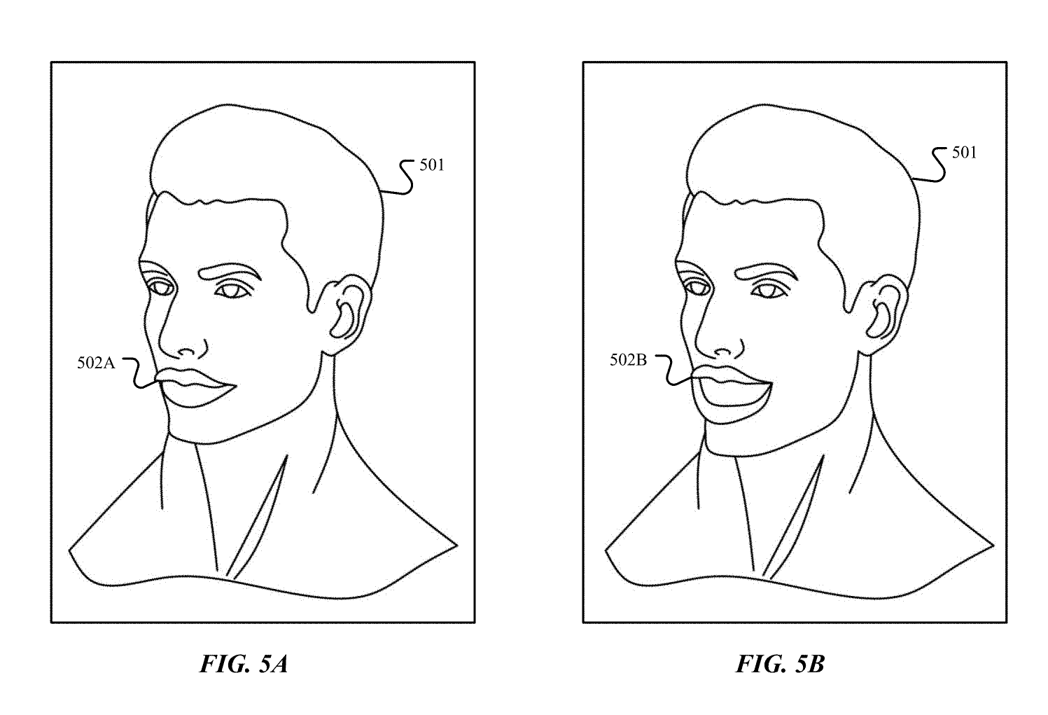

In particular embodiments, the user may deform any part of an object. For example, after a user selects the eyes, the user may enlarge or shrink them by using a type of user interface (e.g., a slide bar). Based on such user action, the computing device 101 may identify what specific part of the object the user is interested in and accordingly enable particular deformation of the selected part of the object. The computing device 101 may access the 3-dimensional mesh representation for the object the user wants to deform. The computing device 101 may also access a deformation layer corresponding to the 3-dimensional mesh representation. The deformation layer may store a projected image for each polygon in the 3-dimensional mesh representation after the deformation. For example, a projected image in the deformation layer for a polygon may be different from the polygon in size and shape. To generate AR effects, the computing device 101 may update the 3-dimensional mesh representation based on any detected movement of the object of interest. The computing device 101 may identify polygons that are visible. The computing device 101 may, for each identified polygon, access the corresponding projected image from the deformation layer and re-render the corresponding portion of the object of interest based on the projected image from the deformation layer. FIGS. 5A-5B illustrate an example of a facial part deformation. A user 501 in the FIG. 5A has enlarged lips 502A. Once a video session starts, the enlarged lips 502B are moving as the user 501 is speaking as shown in FIG. 5B. Although this disclosure describes deforming an object or a part of the object as an AR doodle in a particular manner, this disclosure contemplates deforming an object or a part of the object as an AR doodle in any suitable manner.

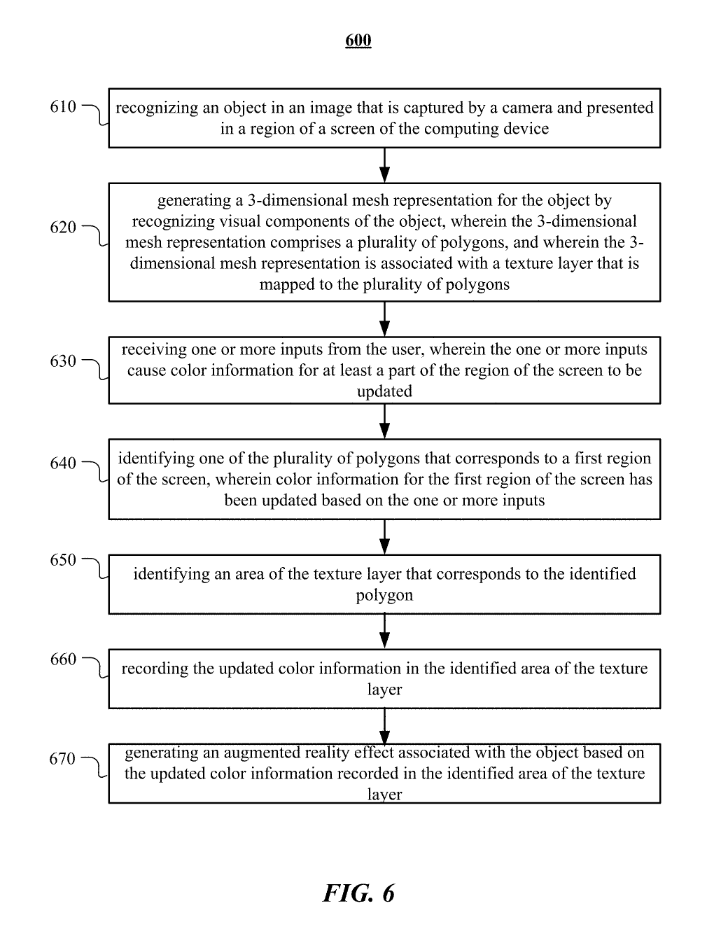

FIG. 6 illustrates an example method 600 for creating augmented reality effects in real-time. The method may begin at step 610, where the computing device 101 may recognize an object in an image that is captured by a camera and presented in a region of a screen of the computing device. At step 620, the computing device 101 may generate a 3-dimensional mesh representation for the object by recognizing visual components of the object, wherein the 3-dimensional mesh representation comprises a plurality of polygons, and wherein the 3-dimensional mesh representation is associated with a texture layer that is mapped to the plurality of polygons. At step 630, the computing device 101 may receive one or more inputs from the user, wherein the one or more inputs cause color information for at least a part of the region of the screen to be updated. At step 640, the computing device 101 may identifying one of the plurality of polygons that corresponds to a first region of the screen, wherein color information for the first region of the screen has been updated based on the one or more inputs. At step 650, the computing device 101 may identify an area of the texture layer that corresponds to the identified polygon. At step 660, the computing device 101 may record the updated color information in the identified area of the texture layer. At step 670, the computing device 101 may generate an augmented reality effect associated with the object based on the updated color information recorded in the identified area of the texture layer. Particular embodiments may repeat one or more steps of the method of FIG. 6, where appropriate. Although this disclosure describes and illustrates particular steps of the method of FIG. 6 as occurring in a particular order, this disclosure contemplates any suitable steps of the method of FIG. 6 occurring in any suitable order. Moreover, although this disclosure describes and illustrates an example method for creating augmented reality effects in real-time including the particular steps of the method of FIG. 6, this disclosure contemplates any suitable method for creating augmented reality effects in real-time including any suitable steps, which may include all, some, or none of the steps of the method of FIG. 6, where appropriate. Furthermore, although this disclosure describes and illustrates particular components, devices, or systems carrying out particular steps of the method of FIG. 6, this disclosure contemplates any suitable combination of any suitable components, devices, or systems carrying out any suitable steps of the method of FIG. 6.

### System Overview

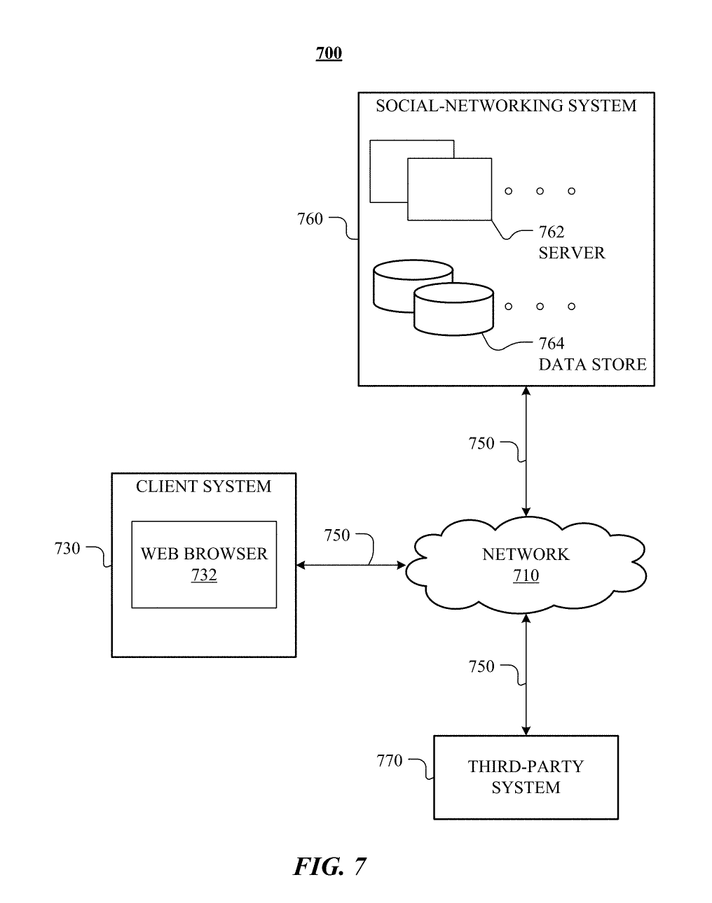

FIG. 7 illustrates an example network environment 700 associated with a social-networking system. Network environment 700 includes a client system 730, a social-networking system 760, and a third-party system 770 connected to each other by a network 710. Although FIG. 7 illustrates a particular arrangement of client system 730, social-networking system 760, third-party system 770, and network 710, this disclosure contemplates any suitable arrangement of client system 730, social-networking system 760, third-party system 770, and network 710. As an example and not by way of limitation, two or more of client system 730, social-networking system 760, and third-party system 770 may be connected to each other directly, bypassing network 710. As another example, two or more of client system 730, social-networking system 760, and third-party system 770 may be physically or logically co-located with each other in whole or in part. Moreover, although FIG. 7 illustrates a particular number of client systems 730, social-networking systems 760, third-party systems 770, and networks 710, this disclosure contemplates any suitable number of client systems 730, social-networking systems 760, third-party systems 770, and networks 710. As an example and not by way of limitation, network environment 700 may include multiple client system 730, social-networking systems 760, third-party systems 770, and networks 710.

This disclosure contemplates any suitable network 710. As an example and not by way of limitation, one or more portions of network 710 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 710 may include one or more networks 710.

Links 750 may connect client system 730, social-networking system 760, and third-party system 770 to communication network 710 or to each other. This disclosure contemplates any suitable links 750. In particular embodiments, one or more links 750 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 750 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 750, or a combination of two or more such links 750. Links 750 need not necessarily be the same throughout network environment 700. One or more first links 750 may differ in one or more respects from one or more second links 750.

In particular embodiments, client system 730 may be an electronic device including hardware, software, or embedded logic components or a combination of two or more such components and capable of carrying out the appropriate functionalities implemented or supported by client system 730. As an example and not by way of limitation, a client system 730 may include a computer system such as a desktop computer, notebook or laptop computer, netbook, a tablet computer, e-book reader, GPS device, camera, personal digital assistant (PDA), handheld electronic device, cellular telephone, smartphone, augmented/virtual reality device, other suitable electronic device, or any suitable combination thereof. This disclosure contemplates any suitable client systems 730. A client system 730 may enable a network user at client system 730 to access network 710. A client system 730 may enable its user to communicate with other users at other client systems 730.

In particular embodiments, client system 730 may include a web browser 732, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client system 730 may enter a Uniform Resource Locator (URL) or other address directing the web browser 732 to a particular server (such as server 762, or a server associated with a third-party system 770), and the web browser 732 may generate a Hyper Text Transfer Protocol (HTTP) request and communicate the HTTP request to server. The server may accept the HTTP request and communicate to client system 730 one or more Hyper Text Markup Language (HTML) files responsive to the HTTP request. Client system 730 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, social-networking system 760 may be a network-addressable computing system that can host an online social network. Social-networking system 760 may generate, store, receive, and send social-networking data, such as, for example, user-profile data, concept-profile data, social-graph information, or other suitable data related to the online social network. Social-networking system 760 may be accessed by the other components of network environment 700 either directly or via network 710. As an example and not by way of limitation, client system 730 may access social-networking system 760 using a web browser 732, or a native application associated with social-networking system 760 (e.g., a mobile social-networking application, a messaging application, another suitable application, or any combination thereof) either directly or via network 710. In particular embodiments, social-networking system 760 may include one or more servers 762. Each server 762 may be a unitary server or a distributed server spanning multiple computers or multiple datacenters. Servers 762 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 762 may include hardware, software, or embedded logic components or a combination of two or more such components for carrying out the appropriate functionalities implemented or supported by server 762. In particular embodiments, social-networking system 760 may include one or more data stores 764. Data stores 764 may be used to store various types of information. In particular embodiments, the information stored in data stores 764 may be organized according to specific data structures. In particular embodiments, each data store 764 may be a relational, columnar, correlation, or other suitable database. Although this disclosure describes or illustrates particular types of databases, this disclosure contemplates any suitable types of databases. Particular embodiments may provide interfaces that enable a client system 730, a social-networking system 760, or a third-party system 770 to manage, retrieve, modify, add, or delete, the information stored in data store 764.

In particular embodiments, social-networking system 760 may store one or more social graphs in one or more data stores 764. In particular embodiments, a social graph may include multiple nodes—which may include multiple user nodes (each corresponding to a particular user) or multiple concept nodes (each corresponding to a particular concept)—and multiple edges connecting the nodes. Social-networking system 760 may provide users of the online social network the ability to communicate and interact with other users. In particular embodiments, users may join the online social network via social-networking system 760 and then add connections (e.g., relationships) to a number of other users of social-networking system 760 to whom they want to be connected. Herein, the term “friend” may refer to any other user of social-networking system 760 with whom a user has formed a connection, association, or relationship via social-networking system 760.

In particular embodiments, social-networking system 760 may provide users with the ability to take actions on various types of items or objects, supported by social-networking system 760. As an example and not by way of limitation, the items and objects may include groups or social networks to which users of social-networking system 760 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 760 or by an external system of third-party system 770, which is separate from social-networking system 760 and coupled to social-networking system 760 via a network 710.

In particular embodiments, social-networking system 760 may be capable of linking a variety of entities. As an example and not by way of limitation, social-networking system 760 may enable users to interact with each other as well as receive content from third-party systems 770 or other entities, or to allow users to interact with these entities through an application programming interfaces (API) or other communication channels.

In particular embodiments, a third-party system 770 may include one or more types of servers, one or more data stores, one or more interfaces, including but not limited to APIs, one or more web services, one or more content sources, one or more networks, or any other suitable components, e.g., that servers may communicate with. A third-party system 770 may be operated by a different entity from an entity operating social-networking system 760. In particular embodiments, however, social-networking system 760 and third-party systems 770 may operate in conjunction with each other to provide social-networking services to users of social-networking system 760 or third-party systems 770. In this sense, social-networking system 760 may provide a platform, or backbone, which other systems, such as third-party systems 770, may use to provide social-networking services and functionality to users across the Internet.

In particular embodiments, a third-party system 770 may include a third-party content object provider. A third-party content object provider may include one or more sources of content objects, which may be communicated to a client system 730. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social-networking system 760 also includes user-generated content objects, which may enhance a user's interactions with social-networking system 760. User-generated content may include anything a user can add, upload, send, or “post” to social-networking system 760. As an example and not by way of limitation, a user communicates posts to social-networking system 760 from a client system 730. Posts may include data such as status updates or other textual data, location information, photos, videos, links, music or other similar data or media. Content may also be added to social-networking system 760 by a third-party through a “communication channel,” such as a newsfeed or stream.

In particular embodiments, social-networking system 760 may include a variety of servers, sub-systems, programs, modules, logs, and data stores. In particular embodiments, social-networking system 760 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking system 760 may also include suitable components such as network interfaces, security mechanisms, load balancers, failover servers, management-and-network-operations consoles, other suitable components, or any suitable combination thereof. In particular embodiments, social-networking system 760 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 760 to one or more client systems 730 or one or more third-party system 770 via network 710. The web server may include a mail server or other messaging functionality for receiving and routing messages between social-networking system 760 and one or more client systems 730. An API-request server may allow a third-party system 770 to access information from social-networking system 760 by calling one or more APIs. An action logger may be used to receive communications from a web server about a user's actions on or off social-networking system 760. In conjunction with the action log, a third-party-content-object log may be maintained of user exposures to third-party-content objects. A notification controller may provide information regarding content objects to a client system 730. Information may be pushed to a client system 730 as notifications, or information may be pulled from client system 730 responsive to a request received from client system 730. Authorization servers may be used to enforce one or more privacy settings of the users of social-networking system 760. A privacy setting of a user determines how particular information associated with a user can be shared. The authorization server may allow users to opt in to or opt out of having their actions logged by social-networking system 760 or shared with other systems (e.g., third-party system 770), such as, for example, by setting appropriate privacy settings. Third-party-content-object stores may be used to store content objects received from third parties, such as a third-party system 770. Location stores may be used for storing location information received from client systems 730 associated with users. Advertisement-pricing modules may combine social information, the current time, location information, or other suitable information to provide relevant advertisements, in the form of notifications, to a user.

### Systems and Methods

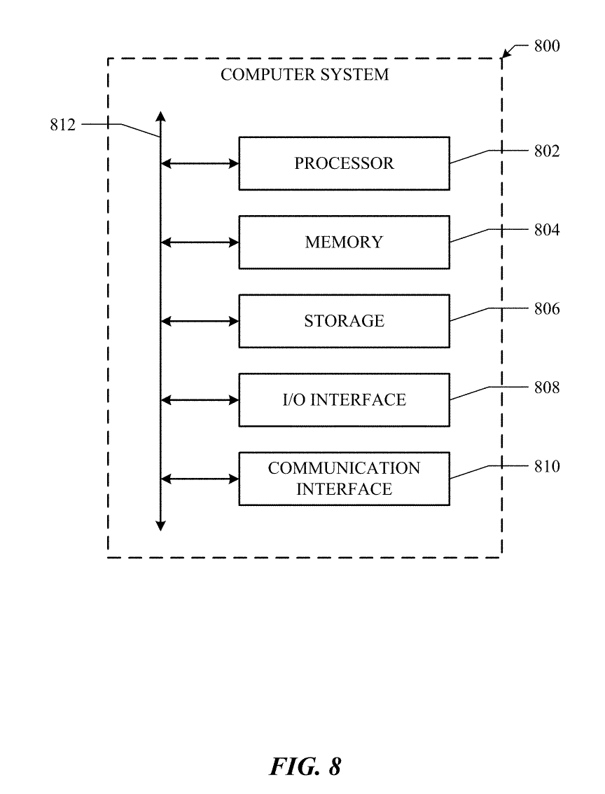

FIG. 8 illustrates an example computer system 800. In particular embodiments, one or more computer systems 800 perform one or more steps of one or more methods described or illustrated herein. In particular embodiments, one or more computer systems 800 provide functionality described or illustrated herein. In particular embodiments, software running on one or more computer systems 800 performs one or more steps of one or more methods described or illustrated herein or provides functionality described or illustrated herein. Particular embodiments include one or more portions of one or more computer systems 800. Herein, reference to a computer system may encompass a computing device, and vice versa, where appropriate. Moreover, reference to a computer system may encompass one or more computer systems, where appropriate.

This disclosure contemplates any suitable number of computer systems 800. This disclosure contemplates computer system 800 taking any suitable physical form. As example and not by way of limitation, computer system 800 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 800 may include one or more computer systems 800; be unitary or distributed; span multiple locations; span multiple machines; span multiple data centers; or reside in a cloud, which may include one or more cloud components in one or more networks. Where appropriate, one or more computer systems 800 may perform without substantial spatial or temporal limitation one or more steps of one or more methods described or illustrated herein. As an example and not by way of limitation, one or more computer systems 800 may perform in real time or in batch mode one or more steps of one or more methods described or illustrated herein. One or more computer systems 800 may perform at different times or at different locations one or more steps of one or more methods described or illustrated herein, where appropriate.

In particular embodiments, computer system 800 includes a processor 802, memory 804, storage 806, an input/output (I/O) interface 808, a communication interface 810, and a bus 812. Although this disclosure describes and illustrates a particular computer system having a particular number of particular components in a particular arrangement, this disclosure contemplates any suitable computer system having any suitable number of any suitable components in any suitable arrangement.

In particular embodiments, processor 802 includes hardware for executing instructions, such as those making up a computer program. As an example and not by way of limitation, to execute instructions, processor 802 may retrieve (or fetch) the instructions from an internal register, an internal cache, memory 804, or storage 806; decode and execute them; and then write one or more results to an internal register, an internal cache, memory 804, or storage 806. In particular embodiments, processor 802 may include one or more internal caches for data, instructions, or addresses. This disclosure contemplates processor 802 including any suitable number of any suitable internal caches, where appropriate. As an example and not by way of limitation, processor 802 may include one or more instruction caches, one or more data caches, and one or more translation lookaside buffers (TLBs). Instructions in the instruction caches may be copies of instructions in memory 804 or storage 806, and the instruction caches may speed up retrieval of those instructions by processor 802. Data in the data caches may be copies of data in memory 804 or storage 806 for instructions executing at processor 802 to operate on; the results of previous instructions executed at processor 802 for access by subsequent instructions executing at processor 802 or for writing to memory 804 or storage 806; or other suitable data. The data caches may speed up read or write operations by processor 802. The TLBs may speed up virtual-address translation for processor 802. In particular embodiments, processor 802 may include one or more internal registers for data, instructions, or addresses. This disclosure contemplates processor 802 including any suitable number of any suitable internal registers, where appropriate. Where appropriate, processor 802 may include one or more arithmetic logic units (ALUs); be a multi-core processor; or include one or more processors 802. Although this disclosure describes and illustrates a particular processor, this disclosure contemplates any suitable processor.

In particular embodiments, memory 804 includes main memory for storing instructions for processor 802 to execute or data for processor 802 to operate on. As an example and not by way of limitation, computer system 800 may load instructions from storage 806 or another source (such as, for example, another computer system 800) to memory 804. Processor 802 may then load the instructions from memory 804 to an internal register or internal cache. To execute the instructions, processor 802 may retrieve the instructions from the internal register or internal cache and decode them. During or after execution of the instructions, processor 802 may write one or more results (which may be intermediate or final results) to the internal register or internal cache. Processor 802 may then write one or more of those results to memory 804. In particular embodiments, processor 802 executes only instructions in one or more internal registers or internal caches or in memory 804 (as opposed to storage 806 or elsewhere) and operates only on data in one or more internal registers or internal caches or in memory 804 (as opposed to storage 806 or elsewhere). One or more memory buses (which may each include an address bus and a data bus) may couple processor 802 to memory 804. Bus 812 may include one or more memory buses, as described below. In particular embodiments, one or more memory management units (MMUs) reside between processor 802 and memory 804 and facilitate accesses to memory 804 requested by processor 802. In particular embodiments, memory 804 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 804 may include one or more memories 804, where appropriate. Although this disclosure describes and illustrates particular memory, this disclosure contemplates any suitable memory.

In particular embodiments, storage 806 includes mass storage for data or instructions. As an example and not by way of limitation, storage 806 may include a hard disk drive (HDD), a floppy disk drive, flash memory, an optical disc, a magneto-optical disc, magnetic tape, or a Universal Serial Bus (USB) drive or a combination of two or more of these. Storage 806 may include removable or non-removable (or fixed) media, where appropriate. Storage 806 may be internal or external to computer system 800, where appropriate. In particular embodiments, storage 806 is non-volatile, solid-state memory. In particular embodiments, storage 806 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 806 taking any suitable physical form. Storage 806 may include one or more storage control units facilitating communication between processor 802 and storage 806, where appropriate. Where appropriate, storage 806 may include one or more storages 806. Although this disclosure describes and illustrates particular storage, this disclosure contemplates any suitable storage.

In particular embodiments, I/O interface 808 includes hardware, software, or both, providing one or more interfaces for communication between computer system 800 and one or more I/O devices. Computer system 800 may include one or more of these I/O devices, where appropriate. One or more of these I/O devices may enable communication between a person and computer system 800. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 808 for them. Where appropriate, I/O interface 808 may include one or more device or software drivers enabling processor 802 to drive one or more of these I/O devices. I/O interface 808 may include one or more I/O interfaces 808, where appropriate. Although this disclosure describes and illustrates a particular I/O interface, this disclosure contemplates any suitable I/O interface.

In particular embodiments, communication interface 810 includes hardware, software, or both providing one or more interfaces for communication (such as, for example, packet-based communication) between computer system 800 and one or more other computer systems 800 or one or more networks. As an example and not by way of limitation, communication interface 810 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 810 for it. As an example and not by way of limitation, computer system 800 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 800 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 800 may include any suitable communication interface 810 for any of these networks, where appropriate. Communication interface 810 may include one or more communication interfaces 810, where appropriate. Although this disclosure describes and illustrates a particular communication interface, this disclosure contemplates any suitable communication interface.

In particular embodiments, bus 812 includes hardware, software, or both coupling components of computer system 800 to each other. As an example and not by way of limitation, bus 812 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 812 may include one or more buses 812, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising:
by a computing device associated with a user, recognizing an object in an image that is captured by a camera and presented in a region of a screen of the computing device;
by the computing device, generating a 3-dimensional mesh representation for the object by recognizing visual components of the object, wherein the 3-dimensional mesh representation comprises a plurality of polygons, and wherein the 3-dimensional mesh representation is associated with a texture layer that is mapped to the plurality of polygons;
by the computing device, receiving one or more inputs from the user, wherein the one or more inputs cause color information for at least a part of the region of the screen to be updated;
by the computing device, identifying one of the plurality of polygons that corresponds to a first region of the screen, wherein color information for the first region of the screen has been updated based on the one or more inputs;
by the computing device, identifying an area of the texture layer that corresponds to the identified polygon;
by the computing device, recording the updated color information in the identified area of the texture layer;
by the computing device, generating an augmented reality effect associated with the object based on the updated color information recorded in the identified area of the texture layer.

2. The method of claim 1, wherein the 3-dimensional mesh representation is updated when the object moves based on a 3-dimensional object tracking algorithm.

3. The method of claim 1, wherein the generating of the augmented reality effect comprises:
updating the 3-dimensional mesh representation based on any detected movement of the object;
determining, based on the updated 3-dimensional mesh representation, that the polygon is visible in a second region of the screen;
retrieving the recorded color information from the area of the texture layer that corresponds to the polygon; and
applying the retrieved color information to the second region of the screen corresponding to the polygon.

4. The method of claim 1, wherein the object is a human face.

5. The method of claim 1, wherein the object is a human body.

6. The method of claim 1, wherein a plurality of objects are presented in the screen, wherein one of the plurality of objects comprises at least another one of the plurality of objects.

7. The method of claim 6, wherein each of the plurality of objects is associated with a 3-dimensional mesh representation.

8. The method of claim 7, further comprising:
selecting the object among the plurality of objects based on a location of the update color information and a degree of required precision.

9. The method of claim 8, wherein selecting the object among the plurality of objects is based on a user selection.

10. The method of claim 1, wherein the updated color information is caused by one or more drawings.

11. One or more computer-readable non-transitory storage media embodying software that is operable when executed to cause a computing device associated with a user to:
recognize an object in an image that is captured by a camera and presented in a region of a screen of the computing device;
generate a 3-dimensional mesh representation for the object by recognizing visual components of the object, wherein the 3-dimensional mesh representation comprises a plurality of polygons, and wherein the 3-dimensional mesh representation is associated with a texture layer that is mapped to the plurality of polygons;
receive one or more inputs from the user, wherein the one or more inputs cause color information for at least a part of the region of the screen to be updated;
identify one of the plurality of polygons that corresponds to a first region of the screen, wherein color information for the first region of the screen has been updated based on the one or more inputs;
identify an area of the texture layer that corresponds to the identified polygon;
record the updated color information in the identified area of the texture layer;
generate an augmented reality effect associated with the object based on the updated color information recorded in the identified area of the texture layer.

12. The media of claim 11, wherein the 3-dimensional mesh representation is updated when the object moves based on a 3-dimensional object tracking algorithm.

13. The media of claim 11, wherein the generating of the augmented reality effect comprises:
updating the 3-dimensional mesh representation based on any detected movement of the object;
determining, based on the updated 3-dimensional mesh representation, that the polygon is visible in a second region of the screen;
retrieving the recorded color information from the area of the texture layer that corresponds to the polygon; and
applying the retrieved color information to the second region of the screen corresponding to the polygon.

14. The media of claim 11, wherein the object is a human face.

15. The media of claim 11, wherein the object is a human body.

16. The media of claim 11, wherein a plurality of objects are presented in the screen, wherein one of the plurality of objects comprises at least another one of the plurality of objects.

17. The media of claim 16, wherein each of the plurality of objects is associated with a 3-dimensional mesh representation.

18. The media of claim 17, wherein the software is further operable when executed to:
select the object among the plurality of objects based on a location of the update color information and a degree of required precision.

19. The media of claim 18, wherein selecting the object among the plurality of objects is based on a user selection.

20. A computing device associated with a user comprising:
one or more processors; and
one or more computer-readable non-transitory storage media coupled to one or more of the processors and comprising instructions operable when executed by one or more of the processors to cause the computing device to:
recognize an object in an image that is captured by a camera and presented in a region of a screen of the computing device;
generate a 3-dimensional mesh representation for the object by recognizing visual components of the object, wherein the 3-dimensional mesh representation comprises a plurality of polygons, and wherein the 3-dimensional mesh representation is associated with a texture layer that is mapped to the plurality of polygons;
receive one or more inputs from the user, wherein the one or more inputs cause color information for at least a part of the region of the screen to be updated;
identify one of the plurality of polygons that corresponds to a first region of the screen, wherein color information for the first region of the screen has been updated based on the one or more inputs;
identify an area of the texture layer that corresponds to the identified polygon;
record the updated color information in the identified area of the texture layer;
generate an augmented reality effect associated with the object based on the updated color information recorded in the identified area of the texture layer.
